(19) United States
(12) Patent Application Publication
(10) Pub. No.: US 2007/0003811 A1
(43) Pub. Date: Jan. 4, 2007

(54) Sealing arrangement for a fuel cell stack and process for the production of such a sealing arrangement

(75) Inventors: Hans-Rainer Zerfass, Taunusstein (DE); Rudolf Henne, Boblingen (DE); Johannes Arnold, Pforzheim (DE)

Correspondence Address: Mr. Edward J. Timmer, P.O. Box 770, Richland, MI, 49083-0770, US

(73) Assignee: ElringKlinger AG

(21) Appl. No.: 11/455,396

(22) Filed: Jun. 19, 2006

(30) Foreign Application Priority Data
Jun. 20, 2005 (DE) 10 2005 029 762.5

(51) Int. Cl. H01M 2/08; F16J 15/10; B05D 5/12

(52) U.S. Cl. 429/35; 277/650; 427/115

(57) ABSTRACT

In order to provide a sealing arrangement for a fuel cell stack, which comprises a plurality of fuel cell units, which are arranged consecutively in a stacking direction, wherein the sealing arrangement has an electrical insulation effect, and which also has an adequate electrical insulation effect and an adequate mechanical strength at a high operating temperature of the fuel cell stack, it is proposed that the sealing arrangement comprises at least one ceramic-metal layer formed from a mixture of a ceramic material and a metal material.

### RELATED APPLICATION

The present disclosure relates to the subject matter disclosed in German Patent Application No. 10 2005 029 762.5 of Jun. 20, 2005, the entire specification of which is incorporated herein by reference.

### FIELD OF THE DISCLOSURE

The present invention relates to a sealing arrangement for a fuel cell stack, which comprises a plurality of fuel cell units, which are arranged consecutively in a stacking direction, wherein the sealing arrangement has an electrical insulation effect.

### BACKGROUND

For adjustment of the desired operating voltage, fuel cell units are arranged one on top of the other in the required number in order to thus form a fuel cell stack. To prevent an electrical short-circuit, the housings of fuel cell units arranged consecutively in the fuel cell stack are electrically insulated from one another. It is additionally necessary to separate the fuel gas ducts of the fuel cell stack from the oxidising agent chambers of the fuel cell units in a gastight manner and the oxidising agent ducts of the fuel cell stack from the fuel gas chambers of the fuel cell units in a gastight manner.

In known fuel cell stacks, sealing and insulation elements made of glass solder or ceramic sealing materials are used in order to obtain the necessary electrical insulation effect and the necessary sealing effect.

In the case of some of the sealing materials usually used, the electrical resistance is no longer sufficiently high at the operating temperature of a high-temperature fuel cell unit (in the range of approximately 800° C. to approximately 900° C.) to attain a satisfactory insulation effect. Moreover, some of the sealing materials usually used have only a low stability with respect to the temperature changes (between operating and resting phases) that frequently arise with a high-temperature fuel cell unit.

The sealing function and electrical insulation function of the sealing arrangement can be separated from one another. Thus, the electrical insulation can be provided by a ceramic coating, which is connected to an adjoining structural part of the fuel cell stack by soldering using a metal solder. In this case, the gastight soldering at the same time brings about the sealing of the fuel gas ducts or the oxidising agent ducts of the fuel cell stack.

However, the insulating ceramic coating can contain pores and/or gaps, in particular when the ceramic coating is applied by thermal spraying to a metal part to be insulated. Depending on the capillary activity of the solder used, the solder can penetrate into the pores or gaps present in the ceramic coating and cause a short-circuit.

### SUMMARY OF THE INVENTION

The object forming the basis of the present invention is to provide a sealing arrangement for a fuel cell stack of the aforementioned type, which also has an adequate electrical insulation effect and an adequate mechanical strength at a high operating temperature of the fuel cell stack.

This object is achieved according to the invention with a sealing arrangement with the features of the preamble of claim 1 in that the sealing arrangement comprises at least one ceramic-metal layer formed from a mixture of a ceramic material and a metal material.

Surprisingly, it has been found that short-circuits as a result of penetrating solder, in particular into thermally sprayed layers of the sealing arrangement, can amazingly be prevented, if the sealing arrangement comprises such a ceramic-metal layer, which preferably is directly in contact with the solder used during soldering of the sealing arrangement.

The present invention is particularly suitable for use with high-temperature fuel cells of the SOFC (solid oxide fuel cell) type.

In a preferred configuration of the invention, the ceramic-metal layer is configured as a cermet layer.

The ceramic-metal layer is preferably a thermally sprayed, in particular an atmospherically plasma-sprayed, vacuum plasma-sprayed or flame-sprayed layer.

It is particularly favourable if the ceramic-metal layer is a high-velocity plasma-sprayed layer, since high-velocity plasma-sprayed layers have a particularly high density and a particularly low porosity.

The process of high-velocity plasma spraying (High Velocity Vacuum Plasma Spraying, abbreviated to HV-VPS) is described, for example, in the article by R. Henne, W. Mayr and A. Reusch: “Einfluβ der Düsenkontur beim Hochgeschwindigkeits-Vakuumplasmaspritzen” [Effect of nozzle contour in high-velocity vacuum plasma spraying], in DVS Reports DVS 152, Thermal Spraying Conference TS 93, Mar. (3-5), 1993, Aachen, Germany, pages 7-11, or in the article by R. Henne, V. Borck, D. Siebold, W. Mayr, A. Reusch, M. Rahmane, G. Soncy, M. Boulos: “Converging-Diverging Nozzles for Improved Atmospheric Plasma Spraying” in VDI Reports No. 1166, 1995, pages 247-266.

Templates can be used during the thermal spraying for lateral restriction of the ceramic-metal layer.

The following plasma gases or plasma gas combinations can be used in particular during plasma spraying:
argon;
nitrogen;
argon and helium;
argon and hydrogen;
argon, helium and hydrogen.

The ceramic-metal layer can be formed in particular from a mixture of a ceramic material in powder form and a metal powder.

It is favourable for the mechanical stability of the ceramic-metal layer if the metal powder comprises a high-temperature corrosion-resistant metal alloy. As a result of this, an adequate corrosion resistance of the ceramic-metal layer is also achieved at the high operating temperature of an SOFC (solid oxide fuel cell) unit.

In particular, it can be provided that the metal powder comprises an aluminium oxide-forming agent, i.e. an aluminium oxide-forming metal alloy, which remains substantially stable at the high spraying temperature.

For example, suitable metal powders are those comprising so-called MCrAlY-alloys, which contain the metal M (in particular Fe, Ni, Co) as base material and chromium, aluminium and yttrium besides this.

The use of metal powder comprising an FeCrAlY alloy is particularly favourable. A typical FeCrAlY alloy has the following composition: 30% by wt. of chromium, 5% by wt. of aluminium, 0.5% by wt. of yttrium, the rest iron.

Aluminium oxide and/or titanium dioxide and/or zirconium dioxide and/or magnesium oxide can be used, for example, as ceramic material in powder form for the formation of the ceramic-metal layer.

It is particularly favourable if the ceramic material of the ceramic-metal layer comprises yttrium-stabilised zirconium dioxide and/or an aluminium-magnesium spinel.

The average mixing ratio of the ceramic material to the metal material of the ceramic-metal layer in parts by weight advantageously amounts to approximately 1:1 to approximately 8:1, preferably from approximately 2:1 to approximately 6:1.

The mixing ratio of the ceramic material to the metal material in the ceramic-metal layer can be substantially constant within the ceramic-metal layer, or can vary in the direction of the layer thickness, i.e. in a direction directed perpendicular to the main surfaces of the ceramic-metal layer.

The variation in mixing ratio can be achieved, for example, by controlled separate injection of the ceramic material and metal material components, wherein mixing occurs in the spray jet.

If the ceramic-metal layer is soldered to a structural part of the fuel cell stack by means of a metal solder layer, then it is advantageously provided that the proportion by weight of the metal material in the ceramic-metal layer decreases with increasing distance from the solder layer.

The average layer thickness of the ceramic-metal layer is advantageously from approximately 10 μm to approximately 100 μm, preferably from approximately 30 μm to approximately 50 μm.

In order to ensure the electrical insulating effect of the sealing arrangement, it is preferably provided that in addition to the ceramic-metal layer, the sealing arrangement comprises an insulation layer composed of an electrically insulating ceramic material.

If the ceramic-metal layer is soldered to a structural part of the fuel cell stack by means of a metal solder layer, then the insulation layer is preferably arranged on the side of the ceramic-metal layer remote from the solder layer.

It has proved beneficial if the insulation layer is a thermally sprayed, in particular atmospherically plasma-sprayed, vacuum plasma-sprayed or flame-sprayed layer.

It is particularly favourable if the insulation layer is a high-velocity plasma-sprayed layer, since a high-velocity plasma-sprayed layer has a particularly high density and low porosity.

In principle, the insulation layer can be formed from any ceramic material, which has an adequately high specific electrical resistance at the operating temperature of the fuel cell stack.

The ceramic material of the insulation layer can comprise in particular aluminium oxide and/or titanium dioxide and/or zirconium dioxide and/or magnesium oxide.

The ceramic material of the insulation layer preferably comprises an aluminium-magnesium spinel.

The average layer thickness of the insulation layer is advantageously from approximately 50 μm to approximately 200 μm, preferably from approximately 100 μm to approximately 140 μm.

In order to create a connection of the sealing arrangement to adjoining structural parts, in particular metal structural parts, of the fuel cell stack, it can be provided that in addition to the ceramic-metal layer, the sealing arrangement comprises a metal solder layer.

In particular it can be provided that the solder layer contains a thermally sprayed solder material.

The solder material can be applied partially by thermal spraying and partially by another process, e.g. by a screen printing process.

In particular, it can be provided that a first solder component (e.g. copper oxide and titanium hydride) is applied by thermal spraying and at a later stage a second solder component (e.g. a silver paste) is applied by a screen printing process.

In this case, the solder components only join at the location, where both solder components have been applied, to form a eutectic, by means of which a soldered joint can be produced with an adjoining structural part of the fuel cell stack.

A solder material to be used for the solder layer can be in particular a solder with at least one reactive component (i.e. a so-called reactive solder), which allows a layer containing ceramic to be directly soldered to metal structural parts of the fuel cell stack.

So-called active solders, which contain active elements such as titanium, for example, are also suitable.

Such a solder is commercially available under the name Copper-ABA from Wesgo Metals, 2425 Whipple Road, Hayward, Calif. 94544, USA.

This solder has the following composition: 2% by wt. of Al; 92.7% by wt. of Cu; 3% by wt. of Si; 2.3% by wt. of Ti.

The solder layer can also contain a silver-based solder, for example, Such a silver-based solder can be used with or without added elemental copper.

If the silver-based solder is used without added elemental copper, then it is favourable if the silver-based solder contains added copper oxide, since the silver-based solder wets ceramic surfaces better as a result of the added copper oxide.

In addition, the solder layer can comprise added titanium to improve wetting.

To reduce the number of different structural parts of the fuel cell stack, it is favourable if the sealing arrangement is configured as a coating on a preferably metal structural part of a fuel cell unit of the fuel cell stack.

Moreover, it can be provided that the sealing arrangement is soldered to a preferably metal structural part of a fuel cell unit of the fuel cell stack.

Claim 31 relates to a fuel cell stack, which comprises a plurality of fuel cell units, which are arranged consecutively in a stacking direction, and at least one sealing arrangement according to the invention.

A further object forming the basis of the present invention is to provide a process for the production of an electrically insulating sealing arrangement for a fuel cell stack, which comprises a plurality of fuel cell units, which are arranged consecutively in a stacking direction, by means of which the housing of the fuel cell units can be connected to one another such that an adequate electrical insulation effect and an adequate mechanical strength are also assured at high operating temperature.

This object is achieved according to the invention by a process, which comprises the following process step:
production of a ceramic-metal layer from a mixture of a ceramic material and a metal material.

Special configurations of the process according to the invention are the subject of claims 33 to 61, the advantages of which have already been explained above in association with special configurations of the sealing arrangement according to the invention.

Further features and advantages of the invention are the subject of the following description and the drawing representing an embodiment.

### BRIEF DESCRIPTION OF THE DRAWINGS

FIG. 1 is a schematic exploded view of the elements of a fuel cell unit;

FIG. 2 is a schematic exploded view of the fuel cell unit from FIG. 1, after a substrate of a CEA (cathode-electrolyte-anode) unit of the fuel cell unit has been soldered to a housing upper part of the fuel cell unit;

FIG. 3 is a schematic exploded view of the fuel cell unit from FIG. 2, after an intermediate element of the fuel cell unit has been soldered to a housing lower part of the fuel cell unit;

FIG. 4 is a schematic exploded view of the fuel cell unit from FIG. 3, after the housing upper part and the housing lower part have been welded to one another, and of a further second fuel cell unit arranged below this first fuel cell unit in the stacking direction of a fuel cell stack;

FIG. 5 is a schematic perspective view of the two fuel cell units from FIG. 4, after the intermediate element of the first fuel cell unit has been welded to the housing upper part of the second fuel cell unit;

FIG. 6 is a schematic plan view from above onto a fuel cell stack;

FIG. 7 is a sectional perspective view of the fuel cell stack, viewed in partial section in the region of a fuel gas duct;

FIG. 8 is a schematic view in vertical section through the fuel cell stack in the region of a fuel gas duct, taken along line 8-8 in FIG. 6;

FIG. 9 is a cutout section from FIG. 8 showing a vertical section through only one fuel cell unit of the fuel cell stack;

FIG. 10 is an enlarged exploded view of region I in FIG. 9;

FIG. 11 is a sectional perspective view of the fuel cell stack, viewed in partial section in the region of an oxidising agent duct;

FIG. 12 is a schematic view in vertical section through the fuel cell stack in the region of an oxidising agent duct, taken along line 12-12 in FIG. 6;

FIG. 13 is a cutout section from FIG. 12 showing a vertical section through only one fuel cell unit of the stack;

FIG. 14 is a sectional perspective view of the fuel cell stack, viewed in partial section in a region outside the fluid ducts;

FIG. 15 s a schematic view in vertical section through the fuel cell stack in a region outside the fluid ducts, taken along line 15-15 in FIG. 6; and

FIG. 16 is a cutout section from FIG. 15 showing only one of the fuel cell units of the fuel cell stack.

Identical or functionally equivalent elements have been given the same reference numerals in all the figures.

### DETAILED DESCRIPTION OF THE INVENTION

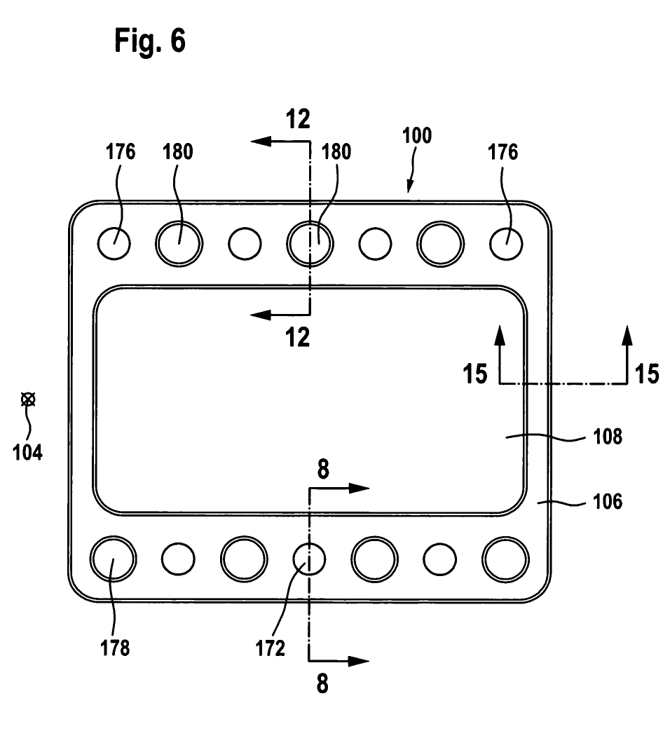

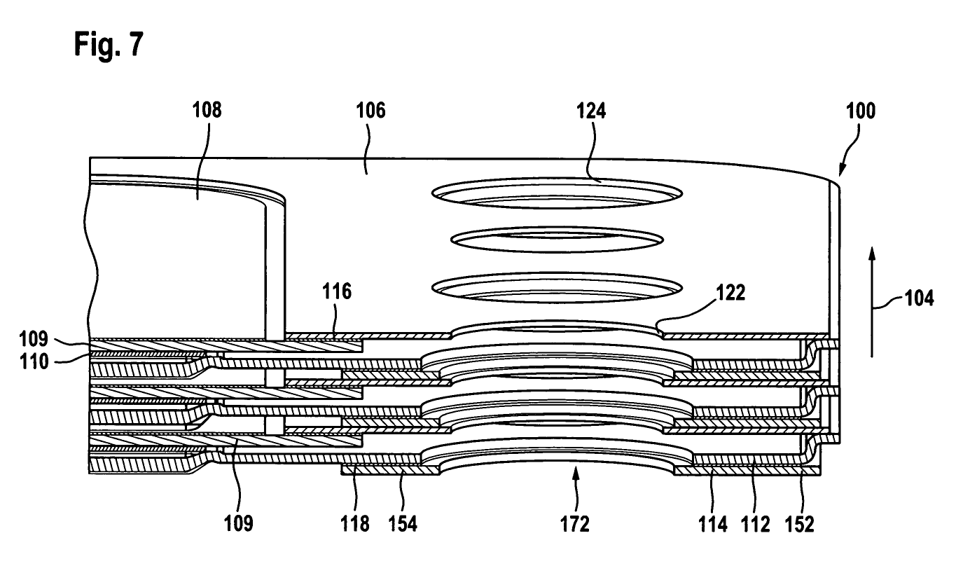

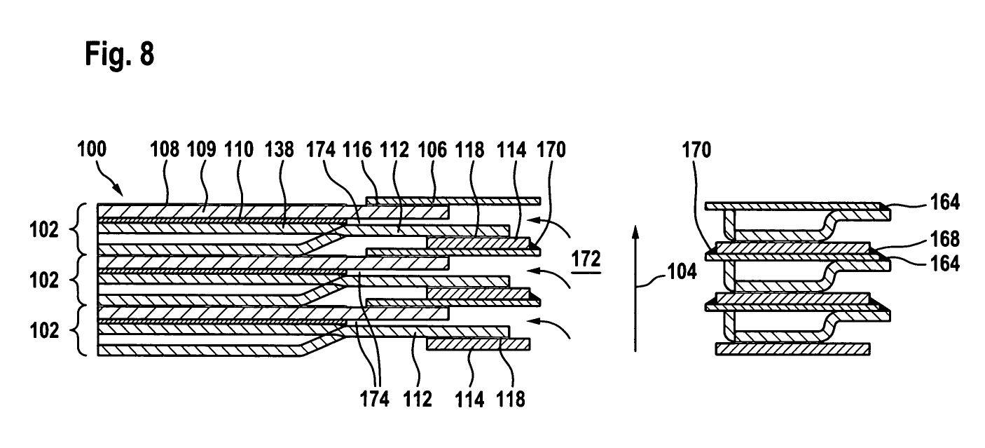

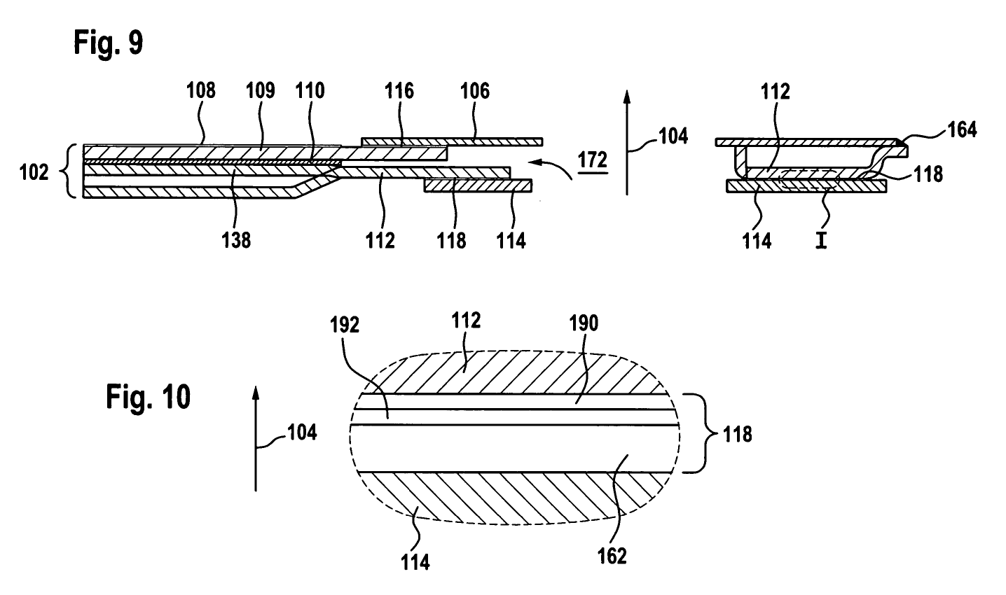

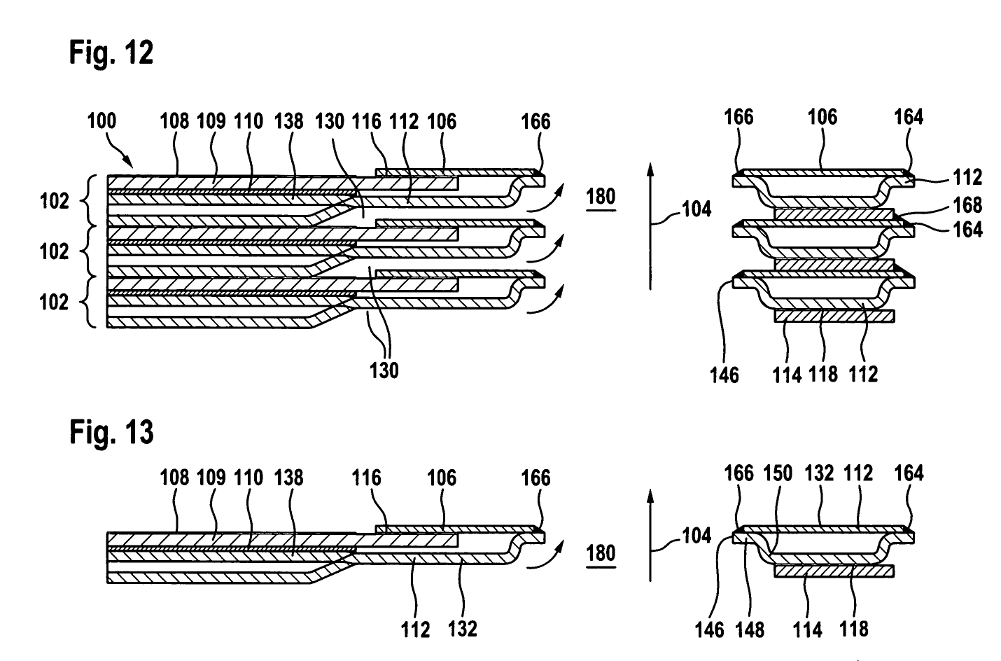

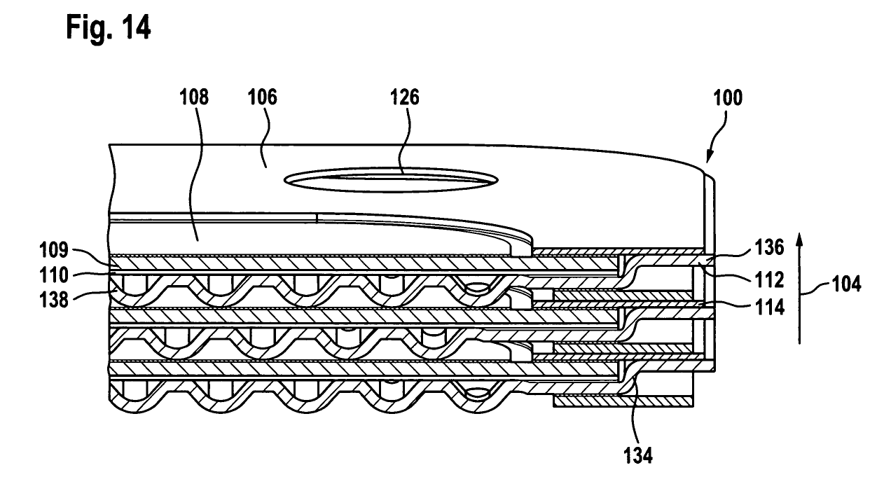

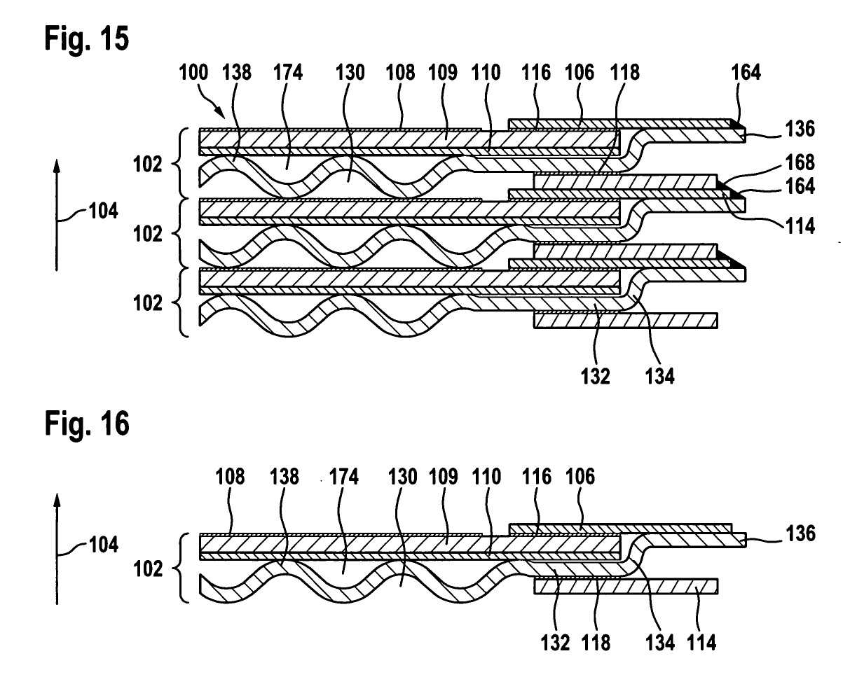

A fuel cell stack shown in FIGS. 5 to 16, given the overall reference 100, comprises a plurality of fuel cell units 102, each having the same structure, which are stacked on top of one another in a vertical stacking direction 104.

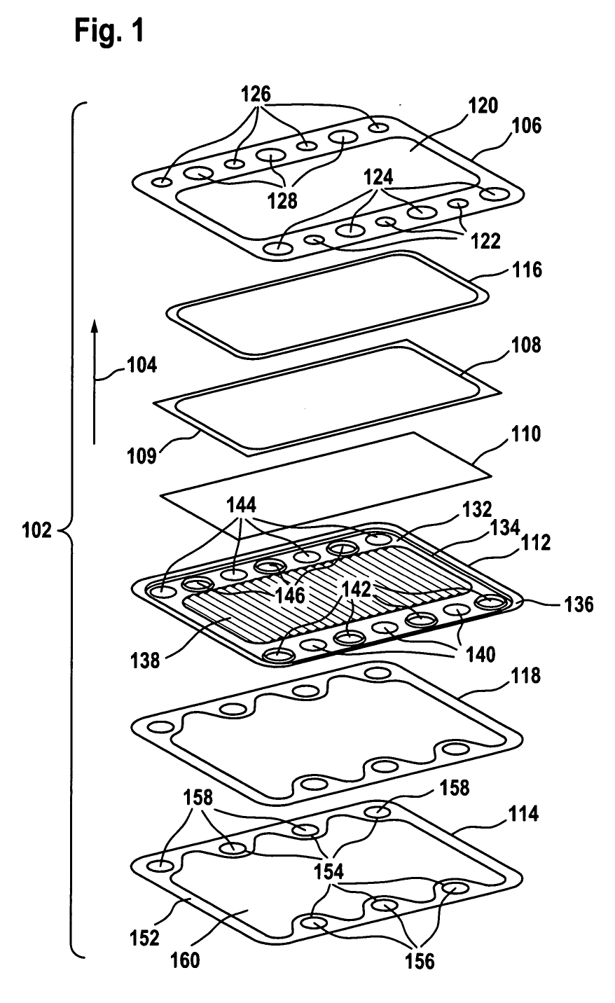

Each of the fuel cell units 102 comprises the components shown individually in FIG. 1, namely a housing upper part 106, a cathode-electrolyte-anode unit (CEA unit) 108 on a substrate 109, a contact material 110, a housing lower part 112 and an intermediate element 114.

FIG. 1 additionally shows a solder layer 116 for soldering the substrate 109 to the housing upper part 106 and a sealing arrangement 118 for connecting the intermediate element 114 to the housing lower part 112 in a gastight and electrically insulating manner.

The housing upper part 106 is configured as a substantially rectangular and substantially plane sheet metal plate, which is provided with a substantially rectangular central passage 120, through which in the finished assembled state of the fuel cell unit the CEA unit 108 of the fuel cell unit 102 is accessible for contacting through the housing lower part 112 of the fuel cell unit 102 located above it in the stacking direction 104.

On one side of the passage 120 the housing upper part 106 is provided with a plurality of, e.g. three, fuel gas feed openings 122, which are arranged alternately with a plurality of, e.g. four, oxidising agent feed openings 124.

On the opposite side of the passage 120 the housing upper part 106 is provided with a plurality of, e.g. four, fuel gas discharge openings 126, which are arranged alternately with a plurality of, e.g. three, oxidising agent discharge openings 128.

The housing upper part 106 is preferably made from a highly corrosion-resistant steel, e.g. from the alloy Crofer 22.

The material Crofer 22 has the following composition:

22% by weight of chromium, 0.6% by weight of aluminium, 0.3% by weight of silicon, 0.45% by weight of manganese, 0.08% by weight of titanium, 0.08% by weight of lanthanum, the rest iron.

This material is distributed by ThyssenKrupp VDM GmbH, Plettenberger Straβe 2, 58791 Werdohl, Germany.

The CEA unit 108 comprises an anode arranged directly on the upper side of the substrate 109, an electrolyte arranged above the anode and a cathode arranged above the electrolyte, wherein these individual layers of the CEA unit 108 are not illustrated individually in the drawings.

The anode is formed from a ceramic material, which is electrically conductive at the operating temperature of the fuel cell unit (from approximately 800° C. to approximately 900° C.), e.g. ZrO₂ or an Ni/ZrO₂ cermet (ceramic-metal mixture), which is porous to enable a fuel gas passing through the substrate 109 to pass through the anode to the electrolyte adjoining the anode.

A gas mixture containing hydrocarbons or pure hydrogen, for example, can be used as fuel gas.

The electrolyte is preferably a solid electrolyte, in particular in the form of a solid oxide electrolyte, and is composed, for example, from yttrium-stabilised zirconium dioxide.

The electrolyte is electronically non-conductive at both normal and operating temperature. In contrast, its ionic conductivity increases as the temperature increases.

The cathode is formed from a ceramic material, which is electrically conductive at the operating temperature of the fuel cell unit, e.g. (Lao_{0.8}Sr_{0.2})_{0.98}MnO₃, and is porous to enable an oxidising agent, e.g. air or pure oxygen, from an oxidising agent chamber 130 adjoining the cathode to pass to the electrolyte.

The edge of the substantially parallelepipedal substrate 109 extends beyond the edge of the CEA unit 108.

The gastight electrolyte of the CEA unit 108 extends beyond the edge of the gas-permeable anode and beyond the edge of the gas-permeable cathode, and with its underside lies directly on the upper side of the edge region of the substrate 109.

The substrate 109 can be configured, for example, as a porous sintered body made of sintered metal particles.

The contact material 110, which is arranged between the substrate 109 and the housing lower part 112, can be, for example, a mesh, knitted fabric or nonwoven fabric made of nickel wire.

The housing lower part 112 is configured as a sheet metal moulding and comprises a substantially rectangular plate 132, which is oriented perpendicular to the stacking direction 104 and which merges at its edges via a sloping section 134 into an edge flange 136, which is likewise oriented substantially perpendicular to the stacking direction 104.

The plate 132 has a substantially rectangular central contact field 138, which is provided with contact elements for connecting the contact material 110 on one side and the cathode of a CEA unit 108 of an adjacent fuel cell unit 102 on the other side, and said contact elements can be configured, for example, in corrugated sheet or studded form.

On one side of the contact field 138, the plate 132 is provided with a plurality of, e.g. three, fuel gas feed openings 140, which are alternately arranged with a plurality of, e.g. four, oxidising agent feed openings 142.

The fuel gas openings 140 and the oxidising agent feed openings 142 of the housing lower part 112 are in alignment with the fuel gas feed openings 122 and the oxidising agent feed openings 124 respectively of the housing upper part 106.

On the other side of the contact field 138, the plate 132 is provided with a plurality of, e.g. four, fuel gas discharge openings 144, which are alternately arranged with a plurality of, e.g. three, oxidising agent discharge openings 146.

The fuel gas discharge openings 144 and the oxidising agent discharge openings 146 of the housing lower part 112 are in alignment with the fuel gas discharge openings 126 and with the oxidising agent discharge openings 128 respectively of the housing upper part 106.

Oxidising agent discharge openings 146 preferably lie opposite fuel gas feed openings 140, and fuel gas discharge openings 144 preferably lie opposite oxidising agent feed openings 142.

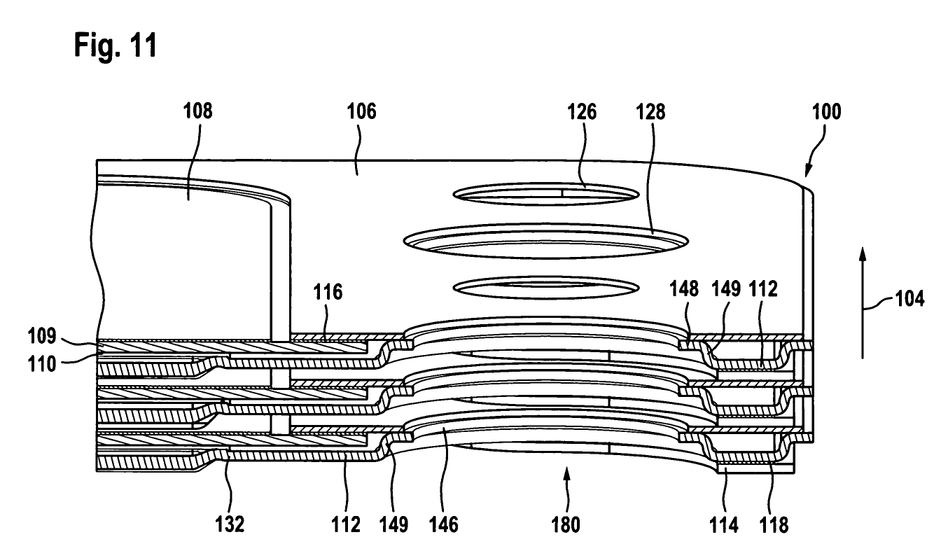

As may best be seen from FIGS. 11 to 13, the oxidising agent discharge openings 146 (like oxidising agent feed openings 142) of the housing lower part 112 are respectively surrounded by a ring flange 148, which surrounds the respective opening in a ring shape and is oriented substantially perpendicular to the stacking direction 104 and which is connected to the plate 132 of the housing lower part 112 via a sloping section 149.

The housing lower part 112 is preferably made from a highly corrosion-resistant steel, e.g. from the alloy Crofer 22 already mentioned above.

The intermediate element 114 comprises a substantially rectangular frame part 152, which extends in a ring shape along the edge of the fuel cell unit 102, and also duct boundary parts 154, which are connected in one piece with the frame part 152 and are configured so that together with the frame part 152 they enclose a respective fuel gas feed opening 156 or a respective fuel gas discharge opening 158 of the intermediate element 114.

Fuel gas feed openings 156 and fuel gas discharge openings 158 of the intermediate element 114 are in alignment with fuel gas feed openings 140 and fuel gas discharge openings 122 respectively of the housing lower part 112 and with fuel gas feed openings 122 and fuel gas discharge openings 126 respectively of the housing upper part 106.

The intermediate element 114 is made from a substantially plane metal sheet by stamping out fuel gas feed openings 156 and fuel gas discharge openings 158 as well as a central passage 160.

A highly corrosion-resistant steel, e.g. the alloy Crofer 22 already mentioned above, is preferably used as material for the intermediate element 114.

As may be seen from FIG. 10, the intermediate element 114 is provided on its upper side facing the housing lower part 112 with a multilayered sealing arrangement 118.

The sealing arrangement 118 comprises an insulation layer 162 arranged directly on the upper side of the intermediate element 114, a ceramic-metal layer 192 arranged on the upper side of the insulation layer 162 remote from the intermediate element 114, and a solder layer 190 arranged on the upper side of the ceramic-metal layer 192 remote from the insulation layer 162.

The insulation layer 162 applied directly onto the upper side of the intermediate element 114 is composed of thermally sprayed ceramic, e.g. of an aluminium-magnesium spinel.

Atmospheric plasma spraying, vacuum plasma spraying or flame spraying, for example, are suitable for applying this electrically insulating insulation layer 162 to the upper side of the intermediate layer 114. High-velocity plasma spraying (High Velocity Vacuum Plasma spraying, HV-VPS) is particularly suitable.

In this process, a spray jet is preferably directed over the surface of the intermediate element 114 to be coated with the insulation layer 162 a plurality of times, wherein a respective layer of thermally sprayed ceramic forms on each application.

The layer thickness of the electrically insulating insulation layer 162 amounts, for example, to 50 μm to 200 μm, preferably 100 μm to 140 μm.

The insulation layer 162 can be formed, for example, by repeated applications to the surface of the intermediate element 114 to be coated, wherein the insulation layer 162 then consists of a plurality of layers of the thermally sprayed ceramic material deposited one on top of the other.

The ceramic-metal layer 192 of the sealing arrangement 118 is configured as a thermally sprayed cermet layer, which is produced from a mixture of a ceramic material in powder form and a metal powder.

Atmospheric plasma spraying, vacuum plasma spraying or flame spraying, for example, are suitable for the thermal spraying of the ceramic-metal layer 192 onto the upper side of the insulation layer 162 remote from the intermediate element 114. High-velocity plasma spraying (High Velocity Vacuum Plasma spraying, HV-VPS) is particularly suitable.

High-temperature corrosion-resistant metal alloys such as aluminium oxide-forming agents, for example, are preferably used as metal powder for the formation of the ceramic-metal layer 192, these remaining substantially stable at the high spraying temperature.

Metal powders composed of so-called MCrAlY-alloys are particularly suitable, these containing the metal M (in particular Fe, Ni, Co) as base material and chromium, aluminium and yttrium besides this.

The use of metal powder comprising an FeCrAlY alloy is particularly favourable. A typical FeCrAlY alloy has the following composition: 30% by wt. of chromium, 5% by wt. of aluminium, 0.5% by wt. of yttrium, the rest iron.

Yttrium-stabilised zirconium dioxide (with an yttrium component measured in % mol of between 3% and 12%, preferably between 5% and 8%) or an aluminium-magnesium spinel can be used, for example, as ceramic material in powder form for the formation of the ceramic-metal layer.

The mixing ratio between the proportions by weight of the ceramic material and the metal material (in particular MCrAlY) lies, for example, in the range of 1:1 to 8:1, preferably in the range of 2:1 to 6:1. A mixing ratio of 4:1 is particularly favourable.

The layer thickness of the ceramic-metal layer 192 lies, for example, in the range of 10 μm to 100 μm, preferably in the range of 30 μm to 50 μm.

The ceramic-metal layer 192 is preferably produced such that a spray jet is directed a plurality of times over the surface of the insulation layer 162 to be coated, wherein a layer of ceramic-metal layer 192 is formed on each application.

The ceramic-metal layer 192 is preferably formed from four such layers.

In this case, on each application to the surface to be coated, the mixing ratio between the ceramic material and the metal powder is varied such that a mixing ratio gradient running in the direction of the layer thickness (parallel to the stacking direction 104) is formed. This mixing ratio gradient is directed such that the proportion by weight of the metal powder in the total material of the ceramic-metal layer 192 increases with increasing distance from the surface of the insulation layer 162.

The solder layer 190 of the sealing arrangement 118 is composed of a silver-based solder, which is applied to the upper side of the ceramic-metal layer 192 remote from the insulation layer 162.

In principle, the solder layer 190 can also be generated by thermal spraying, in particular by atmospheric plasma spraying, vacuum plasma spraying or flame spraying. High-velocity plasma spraying (High Velocity Vacuum Plasma spraying, HV-VPS) is particularly suitable.

The solder material used can be a silver-based solder with added elemental copper, e.g. a silver-based solder with the composition (in % mol.) of Ag-4Cu or Ag-8Cu.

The soldering of this solider layer 190 to the underside of the housing lower part 112 is conducted in an atmosphere of air. The soldering temperature amounts to 1050° C., for example, the soldering time amounts to approximately 5 minutes, for example. Copper oxide is formed in situ during the soldering in air.

Alternatively, the solder layer 190 can also be formed from a silver-based solder without added elemental copper. Such a copper-free solder has the advantage of a higher solidus temperature (this amounts to approximately 960° C. without copper addition and approximately 780° C. with copper addition). Since pure silver does not wet ceramic surfaces, copper(II)oxide is added to silver-based solders without added copper to reduce the wetting angle. Soldering with silver-based solders without added copper is conducted in an atmosphere of air or in a protective gas atmosphere, e.g. with argon.

Suitable silver-based solders without added elemental copper have the composition (in % mol.), for example, of Ag-4CuO or Ag-8CuO.

An addition of titanium to the solder material of the solder layer 190 can be used to further improve the wetting (reduce the wetting angle). An intimate mix of the appropriate components in powder form is used to produce the solders. The soldering alloy is formed in situ from this intimate mixt. Titanium is added to this intimate mix in the form of titanium hydride. A metallic titanium is formed from the hydride at approximately 400° C.

Suitable silver-based solders for the solder layer 190 without added elemental copper, but with added titanium, have the composition (in % mol.), for example, of Ag-4CuO-0.5Ti or Ag-8CuO-0.5Ti.

In this case, the soldering temperature likewise preferably amounts to approximately 1050° C. and the soldering time amounts to approximately 5 minutes, for example.

Because the sealing arrangement 118 has the ceramic-metal layer 192 arranged between the solder layer 190 and the insulation layer 162, no short circuits occur as a result of solder penetrating into the insulation layer 162, and therefore the sealing arrangement 118 can perform its electrical insulation function perfectly.

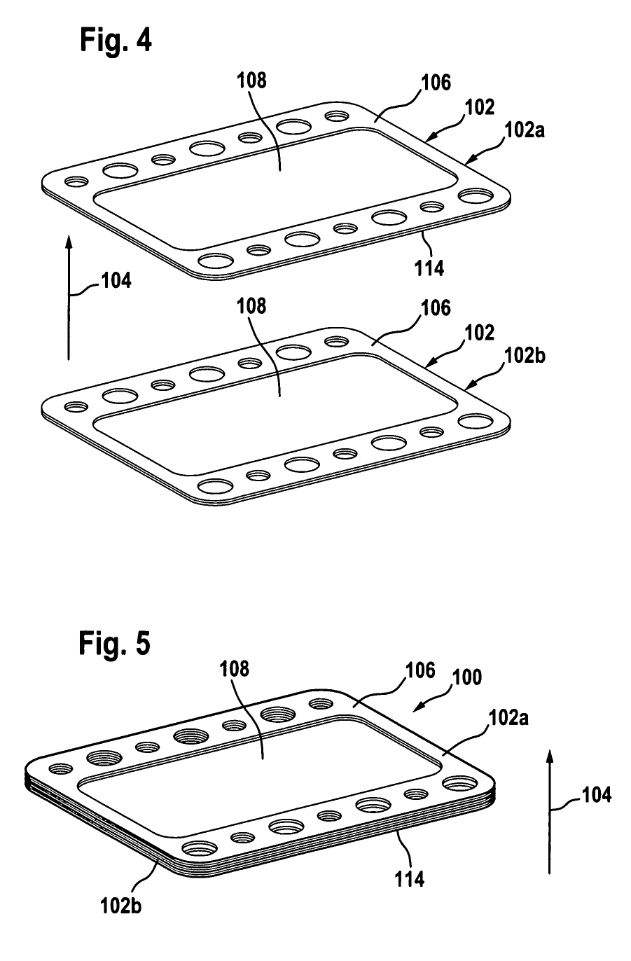

The procedure for the production of the fuel cell units 102 shown in FIG. 4 from the above-described individual elements is as follows:

Firstly, the intermediate element 114 is provided with the sealing arrangement 118 in the above-described manner.

The substrate 109, on which the CEA unit 108 is arranged, is then soldered along the edge of its upper side to the housing upper part 106, i.e. on the underside of the region of the housing upper part 106 surrounding the passage 120 in the housing upper part 106.

As shown in FIG. 1, the solder material required for this can be inserted as an appropriately cut to size soldering foil 116 between the substrate 109 and the housing upper part 106, or can be applied in the form of a bead of solder material to the upper side of the substrate 109 and/or to the underside of the housing upper part 106 by means of a dispenser. Moreover, it is also possible to apply the solder material by means of a pattern printing process, e.g. a screen printing process, to the upper side of the substrate 109 and/or to the underside of the housing upper part 106.

A silver-based solder with added copper can be used as solder material, e.g. a silver-based solder with the composition (in % mol.): Ag4Cu or Ag8Cu.

Soldering is conducted in an atmosphere of air. The soldering temperature amounts to 1050° C., for example, the soldering time amounts to approximately 5 minutes, for example. Copper oxide is formed in situ during the soldering in air.

Alternatively, a silver-based solder without added copper can also be used. Such a copper-free solder has the advantage of a higher solidus temperature (this amounts to approximately 960° C. without copper addition and approximately 780° C. with copper addition). Since pure silver does not wet ceramic surfaces, copper(II)oxide is added to silver-based solders without added copper to reduce the wetting angle. Soldering with silver-based solders without added copper is conducted in an atmosphere of air or in a protective gas atmosphere, e.g. with argon.

The soldering temperature also preferably amounts to approximately 1050° C. in this case and the soldering time to approximately 5 minutes, for example.

Alternatively to soldering the substrate 109 with the CEA unit 108 arranged thereon into the housing upper part 106, it can also be provided that a substrate 109, on which the CEA unit 108 has not yet been produced, is welded to the housing upper part 106 and after the welding the electrochemically active layers of the CEA unit 108, i.e. its anode, electrolyte and cathode, are produced one after the other on the substrate 109 already welded to the housing upper part 106 by means of the vacuum plasma spraying process.

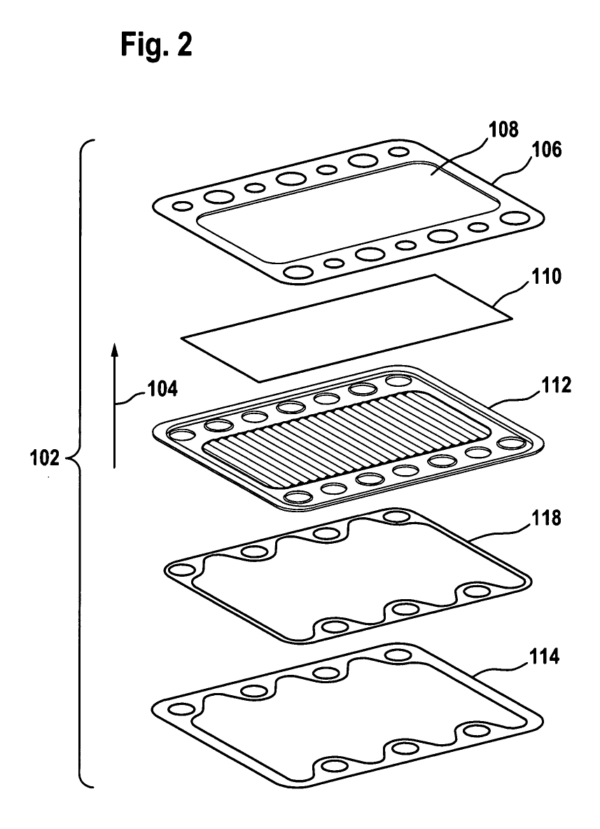

The status shown in FIG. 2 is reached after the substrate 109 is joined to the housing upper part 106.

On its side remote from the housing lower part 112 and provided with the sealing arrangement 118, the intermediate element 114 is now soldered by means of the solder material of the solder layer 190 to the housing lower part 112 on its side facing the intermediate element 114.

In this case, the soldering process can take place under the same conditions as those described above in association with the soldering of the substrate 109 and the housing upper part 106.

Instead of using a solder layer 190 already joined to the ceramic-metal layer 192, the necessary solder material can also be inserted as an appropriately cut to size soldering foil 116 between the intermediate element 114 and the housing lower part 112, or can be applied in the form of a bead of solder material to the upper side of the sealing arrangement 118 and/or to the underside of the housing lower part 112 by means of a dispenser. Moreover, it is also possible to apply the solder material by means of a pattern printing process, e.g. a screen printing process, to the upper side of the sealing arrangement 118 and/or to the underside of the housing lower part 112.

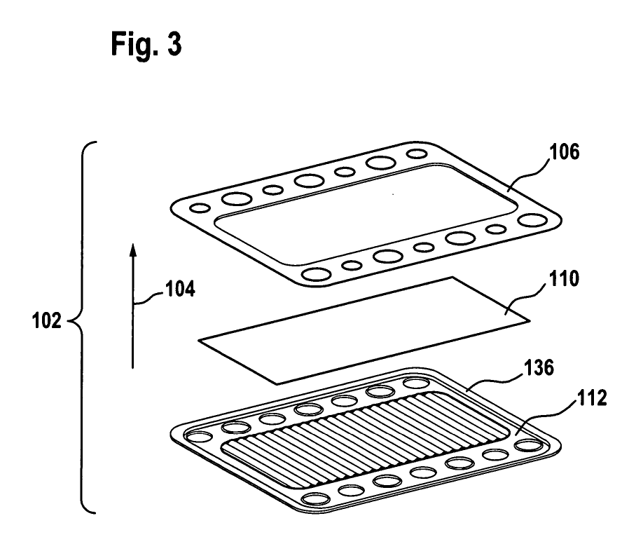

The status shown in FIG. 3 is reached after the intermediate element 114 has been soldered to the housing lower part 112.

However, it is also possible to solder the intermediate element 114 to the housing lower part 112 before the substrate 109 is connected to the housing upper part 106, or the connection of the intermediate element 114 and the housing lower part 112, on the one hand, and of the substrate 109 and the housing upper part 106, on the other, can occur simultaneously.

The contact material 110, e.g. a nickel mesh, is then inserted between the housing lower part 112 and the housing upper part 106, and the housing lower part 112 and the housing upper part 106 are then welded together to be gastight along a weld 164, which runs around the outside edge of the edge flange 136 of the housing lower part 112 and the outside edge of the housing upper part 106, and along welds 166, which run around the inside edges of the ring flanges 148 of the housing lower part 112 and the edges of the oxidising agent feed openings 124 and the oxidising agent discharge openings 128 respectively of the housing upper part 106.

After this process step, the status shown in FIG. 4 is reached, in which ready assembled fuel cell units 102 are present, which must now be connected to one another to form a fuel cell stack 100 comprising a plurality of fuel cell units 102 arranged consecutively in the stacking direction 104.

The connection of two fuel cell units 102 arranged consecutively in the stacking direction 104 is achieved in the following manner:

A first fuel cell unit 102a and a second fuel cell unit 102b are inserted into a welding device so that the upper side of the housing upper part 106 of the second fuel cell unit 102b lies flush against the underside of the intermediate element 114 of the first fuel cell unit 102a.

The intermediate element 114 of the first fuel cell unit 102a is then welded together with the housing upper part 106 of the second fuel cell unit 102b to be gastight by means of a weld 168, which runs along the outside edges of the intermediate element 114 and the housing upper part 106, and by means of welds 170, which run in a ring around the edges of the fuel gas feed openings 156 of the intermediate element 114 and the edges of the fuel gas feed openings 122 of the housing upper part 106 aligned therewith or in a ring around the edges of the fuel gas discharge openings 158 of the intermediate element 114 and the edges of the fuel gas discharge openings 126 of the housing upper part 106 aligned therewith.

After two fuel cell units 102 have been connected to one another in this way, the fuel cell stack 100 can be gradually constructed by successively welding further fuel cell units 102 onto the intermediate element 114 of the second fuel cell unit 102b or onto the housing upper part 106 of the first fuel cell unit 102a in the stacking direction 104 until the desired number of fuel cell units 102 is reached.

In the finished fuel cell stack 100, the respectively aligned fuel gas feed openings 122, 140 and 156 of housing upper parts 106, housing lower parts 112 and intermediate elements 114 respectively form a fuel gas feed duct 172, which in each fuel cell unit 102 between the upper side of the housing lower part 112 and the underside of the housing upper part 106 opens towards a fuel gas chamber 174, which is configured between the upper side of the contact field 138 of the housing lower part 112, on one side, and the underside of the substrate 109 of the CEA unit 108, on the other.

The respectively aligned fuel gas discharge openings 126, 144 and 158 of housing upper parts 106, housing lower parts 112 and intermediate elements 114 respectively form a fuel gas discharge duct 176, which on the side of each fuel cell unit 102 opposite the fuel gas feed ducts 172 in the area between the upper side of the housing lower part 112 and the underside of the housing upper part 106 is open towards the fuel gas chamber 174.

The respectively aligned oxidising agent feed openings 124 and 142 of housing upper parts 106 and housing lower parts 112 as well as the regions of the passages 160 in the intermediate elements 114 lying between the duct boundary parts 154 of the fuel gas feed openings 140 of the intermediate elements 114 together form a respective oxidising agent feed duct 178, which is open towards the oxidising agent chamber 130 of the fuel cell unit 102 in the area of each fuel cell unit 102 between the upper side of the housing upper part 106 and the underside of the housing lower part 112 of the fuel cell unit 102 located above it in the stacking direction 104.

Similarly, the respectively aligned oxidising agent discharge openings 128 and 146 of housing upper parts 106 and housing lower parts 112 respectively together with the regions of the passages 160 in the intermediate elements 114 lying between the duct boundary parts 154 of the fuel gas discharge openings 144 of the intermediate elements 114 form a respective oxidising agent discharge duct 180, which is arranged on the side of the fuel cell units 102 opposite the oxidising agent feed ducts 178 and is likewise open towards the oxidising agent chamber 130 of the fuel cell unit 102 in the area of each fuel cell unit 102 between the upper side of the housing upper part 106 and the underside of the housing lower part 112 of the fuel cell unit 102 located above it in the stacking direction 104.

During the operation of the fuel cell stack 100, a fuel gas is fed to the fuel gas chamber 174 of each fuel cell unit 102 via the fuel gas feed ducts 172, and waste gas resulting from oxidation at the anode of the CEA unit 108 as well as unconsumed fuel gas are discharged from the fuel gas chamber 174 through the fuel gas discharge ducts 176.

Similarly, an oxidising agent, e.g. air, is fed through the oxidising agent feed ducts 178 to the oxidising agent chamber 130 of each fuel cell unit 102 and unconsumed oxidising agent is discharged from the oxidising agent chamber 130 through the oxidising agent discharge ducts 180.

During the operation of the fuel cell stack 100, the CEA units 108 have a temperature of 850° C., for example, at which the electrolyte of each CEA unit 108 is conductive for oxygen ions. The oxidising agent from the oxidising agent chamber 130 absorbs electrons from the cathode and releases di-negatively charged oxygen ions to the electrolytes, which migrate through the electrolyte to the anode. At the anode the fuel gas from the fuel gas chamber 174 is oxidised by the oxygen ions from the electrolyte and therein releases electrons to the anode.

The electrons released during the reaction at the anode are fed by the anode via the substrate 109, the contact material 110 and the housing lower part 112 to the cathode of an adjacent fuel cell unit 102 abutting against the underside of the contact field 138 of the housing lower part 112 and thus enable the cathode reaction.

The housing lower part 112 and housing upper part 106 of each fuel cell unit 102 are electrically conductively connected to one another via the welds 164, 166.

However, the housings 182 of fuel cell units 102 arranged consecutively in the stacking direction 104, which are respectively formed by a housing upper part 106, a housing lower part 112 and an intermediate element 114, are electrically insulated from one another through the sealing arrangements 118 between the upper side of the intermediate elements 114 and the underside of the housing lower parts 112. In this case, as a result of the soldering of the intermediate elements 114 to the housing lower parts 112 a gastight connection between these structural elements is assured at the same time, so that the oxidising agent chambers 130 and the fuel gas chambers 174 of the fuel cell units 102 are separated in a gastight manner from one another and from the ambient area of the fuel cell stack 100.

1. Sealing arrangement for a fuel cell stack, which comprises a plurality of fuel cell units, which are arranged consecutively in a stacking direction, wherein the sealing arrangement has an electrical insulation effect, wherein
the sealing arrangement comprises at least one ceramic-metal layer formed from a mixture of a ceramic material and a metal material.

2. Sealing arrangement according to claim 1, wherein the ceramic-metal layer is configured as a cermet layer.

3. Sealing arrangement according to claim 1, wherein the ceramic-metal layer is a thermally sprayed, in particular atmospherically plasma-sprayed, vacuum plasma-sprayed or flame-sprayed layer.

4. Sealing arrangement according to claim 3, wherein the ceramic-metal layer is a high-velocity plasma-sprayed layer.

5. Sealing arrangement according to claim 1, wherein the ceramic-metal layer is formed from a mixture of a ceramic material in powder form and a metal powder.

6. Sealing arrangement according to claim 5, wherein the metal powder comprises a high-temperature corrosion-resistant metal alloy.

7. Sealing arrangement according to claim 5, wherein the metal powder comprises an aluminium oxide-forming metal alloy.

8. Sealing arrangement according to claim 5, wherein besides a principal metal component, the metal powder also contains chromium, aluminium and/or yttrium.

9. Sealing arrangement according to claim 1, wherein the ceramic material of the ceramic-metal layer comprises aluminium oxide and/or titanium dioxide and/or zirconium dioxide and/or magnesium oxide.

10. Sealing arrangement according to claim 1, wherein the ceramic material of the ceramic-metal layer comprises yttrium-stabilised zirconium dioxide.

11. Sealing arrangement according to claim 1, wherein the ceramic material of the ceramic-metal layer comprises an aluminium-magnesium spinel.

12. Sealing arrangement according to claim 1, wherein the average mixing ratio of the ceramic material to the metal material of the ceramic-metal layer in parts by weight amounts to approximately 1:1 to approximately 8:1, preferably from approximately 2:1 to approximately 6:1.

13. Sealing arrangement according to claim 1, wherein the mixing ratio of the ceramic material to the metal material in the ceramic-metal layer varies in the direction of the layer thickness.

14. Sealing arrangement according to claim 13, wherein the ceramic-metal layer is soldered to a structural part of the fuel cell stack by means of a metal solder layer, and wherein the proportion by weight of the metal material in the ceramic-metal layer decreases with increasing distance from the solder layer.

15. Sealing arrangement according to claim 1, wherein the average layer thickness of the ceramic-metal layer is from approximately 10 μm to approximately 100 μm, preferably from approximately 30 μm to approximately 50 μm.

16. Sealing arrangement according to claim 1, wherein in addition to the ceramic-metal layer, the sealing arrangement comprises an insulation layer composed of an electrically insulating ceramic material.

17. Sealing arrangement according to claim 16, wherein the ceramic-metal layer is soldered to a structural part of the fuel cell stack by means of a metal solder layer, and wherein the insulation layer is arranged on the side of the ceramic-metal layer remote from the solder layer.

18. Sealing arrangement according to claim 16, wherein the insulation layer is a thermally sprayed, in particular atmospherically plasma-sprayed, vacuum plasma-sprayed or flame-sprayed layer.

19. Sealing arrangement according to claim 18, wherein the insulation layer is a high-velocity plasma-sprayed layer.

20. Sealing arrangement according to claim 16, wherein the ceramic material of the insulation layer comprises aluminium oxide and/or titanium dioxide and/or zirconium dioxide and/or magnesium oxide.

21. Sealing arrangement according to claim 16, wherein the ceramic material of the insulation layer comprises an aluminium-magnesium spinel.

22. Sealing arrangement according to claim 16, wherein the average layer thickness of the insulation layer is from approximately 50 μm to approximately 200 μm, preferably from approximately 100 μm to approximately 140 μm.

23. Sealing arrangement according to claim 1, wherein in addition to the ceramic-metal layer, the sealing arrangement comprises a metal solder layer.

24. Sealing arrangement according to claim 23, wherein the solder layer contains a thermally sprayed solder material.

25. Sealing arrangement according to claim 23, wherein the solder layer contains a silver-based solder with added elemental copper.

26. Sealing arrangement according to claim 23, wherein the solder layer contains a silver-based solder without added elemental copper.

27. Sealing arrangement according to claim 26, wherein the silver-based solder contains added copper oxide.

28. Sealing arrangement according to claim 23, wherein the solder layer contains a silver-based solder with added titanium.

29. Sealing arrangement according to claim 1, wherein the sealing arrangement is configured as a coating on a preferably metal structural part of a fuel cell unit of the fuel cell stack.

30. Sealing arrangement according to claim 1, wherein the sealing arrangement is soldered to a preferably metal structural part of a fuel cell unit of the fuel cell stack.

31. Fuel cell stack, comprising a plurality of fuel cell units, which are arranged consecutively in a stacking direction, and at least one sealing arrangement according to claim 1.

32. Process for the production of an electrically insulating sealing arrangement for a fuel cell stack, which comprises a plurality of fuel cell units, which are arranged consecutively in a stacking direction, comprising the following process step:
production of a ceramic-metal layer from a mixture of a ceramic material and a metal material.

33. Process according to claim 32, wherein the ceramic-metal layer is configured as a cermet layer.

34. Process according to claim 32, wherein the ceramic-metal layer is generated by thermal spraying, in particular by atmospheric plasma spraying, by vacuum plasma spraying or by flame spraying.

35. Process according to claim 34, wherein the ceramic-metal layer is generated by high-velocity plasma spraying.

36. Process according to claim 32, wherein the ceramic-metal layer is formed from a mixture of a ceramic material in powder form and a metal powder.

37. Process according to claim 36, wherein a metal powder is used, which comprises a high-temperature corrosion-resistant metal alloy.

38. Process according to claim 36, wherein a metal powder is used, which comprises an aluminium oxide-forming metal alloy.

39. Process according to claim 36, wherein a metal powder is used, which besides a principal metal component, contains chromium, aluminium and/or yttrium.

40. Process according to claim 32, wherein to produce the ceramic-metal layer a ceramic material is used, which comprises aluminium oxide and/or titanium dioxide and/or zirconium dioxide and/or magnesium oxide.

41. Process according to claim 32, wherein to produce the ceramic-metal layer a ceramic material is used, which comprises yttrium-stabilised zirconium dioxide.

42. Process according to claim 32, wherein to produce the ceramic-metal layer a ceramic material is used, which comprises an aluminium-magnesium spinel.

43. Process according to claim 32, wherein to produce the ceramic-metal layer a mixture is used, in which the average mixing ratio of the ceramic material to the metal material in parts by weight is from approximately 1:1 to approximately 8:1, preferably from approximately 2:1 to approximately 6:1.

44. Process according to claim 32, wherein the mixing ratio of the ceramic material to the metal material is varied during production of the ceramic-metal layer.

45. Process according to claim 44, wherein the ceramic-metal layer produced is soldered to a structural part of the fuel cell stack by means of a metal solder layer, and wherein the mixing ratio of the ceramic material to the metal material is varied during production of the ceramic-metal layer such that the proportion by weight of the metal material in the ceramic-metal layer decreases with increasing distance from the solder layer.

46. Process according to claim 32, wherein the ceramic-metal layer is produced with an average layer thickness from approximately 10 μm to approximately 100 μm, preferably from approximately 30 μm to approximately 50 μm.

47. Process according to claim 32, wherein an insulation layer composed of an electrically insulating ceramic material is formed in addition to the ceramic-metal layer.

48. Process according to claim 47, wherein the ceramic-metal layer produced is soldered to a structural part of the fuel cell stack by means of a metal solder layer, and wherein the insulation layer is produced so that it is arranged on the side of the ceramic-metal layer remote from the solder layer.

49. Process according to claim 47, wherein the insulation layer is generated by thermal spraying, in particular by atmospheric plasma spraying, by vacuum plasma spraying or by flame spraying.

50. Process according to claim 49, wherein the insulation layer is generated by high-velocity plasma spraying.

51. Process according to claim 47, wherein for production of the insulation layer a ceramic material is used, which comprises aluminium oxide and/or titanium dioxide and/or zirconium dioxide and/or magnesium oxide.

52. Process according to claim 47, wherein for production of the insulation layer a ceramic material is used, which comprises an aluminium-magnesium spinel.

53. Process according to claim 47, wherein the insulation layer is produced with an average layer thickness from approximately 50 μm to approximately 200 μm, preferably from approximately 100 μm to approximately 140 μm.

54. Process according to claim 32, wherein a metal solder layer is generated in addition to the ceramic-metal layer.

55. Process according to claim 54, wherein the solder layer is at least partially generated by thermal spraying of solder material.

56. Process according to claim 54, wherein a silver-based solder with added elemental copper is used to produce the solder layer.

57. Process according to claim 54, wherein a silver-based solder without added elemental copper is used to produce the solder layer.

58. Process according to claim 57, wherein a silver-based solder, which contains added copper oxide, is used to produce the solder layer.

59. Process according to claim 54, wherein a silver-based solder with added titanium is used to produce the solder layer.

60. Process according to claim 32, wherein the sealing arrangement comprising the ceramic-metal layer is configured as a coating on a preferably metal structural part of a fuel cell unit of the fuel cell stack.

61. Process according to claim 32; wherein the sealing arrangement comprising the ceramic-metal layer is soldered to a preferably metal structural part of a fuel cell unit of the fuel cell stack.
